(19) United States
(12) Patent Application Publication
(10) Pub. No.: US 2020/0164399 A1
(43) Pub. Date: May 28, 2020

(54) METHOD FOR COATING A MATERIAL WEB

(71) Applicant: VOITH PATENT GMBH, HEIDENHEIM (DE)

(72) Inventor: MARTIN SCHMID, BOLHEIM (DE)

(21) Appl. No.: 16/636,089

(22) PCT Filed: Jun. 27, 2018
(86) PCT No.: PCT/EP2018/067174

§ 371 Date: Feb. 14, 2020

(30) Foreign Application Priority Data
Aug. 2, 2017 (DE) 10 2017 117 460.5

(51) Int. Cl. B05C 5/02; B05D 3/02; B05C 9/10; B05C 5/00; B05C 15/00; B05D 1/30; B05B 16/60; D21H 23/48

(52) U.S. Cl. CPC B05C 5/0245; B05D 3/0254; B05C 9/10; D21H 23/48; B05C 15/00; B05D 1/305; B05B 16/60; B05C 5/005

(57) ABSTRACT

A method for coating a material web (2), in particular a fibrous web, by way of a coating device. The coating device (1) has an application unit (3) for applying a coating medium to the material web. The application unit is arranged in the interior of an enclosure (4), which has first opening for the entry of the material web and a second opening for the exiting of the material web. In the interior of the enclosure there is produced a positive pressure greater than the ambient pressure outside the enclosure during the coating so that air flows from the interior of the enclosure to the outside (5b) of the enclosure through the first opening and/or the second opening.

A method for coating a material web, in particular a fibrous web, according to the preamble to claim 1.

The coating of material webs, in particular fibrous webs, has long been established. The coating of paper webs or board webs in particular by means of a curtain application has undergone significant further development in recent years.

This coating process involves the application of a coating medium, e.g. a coating color, onto the material web from a nozzle under the effect of gravity. In order to achieve uniform coating qualities, the coating medium is applied to the material web in the form of a thin curtain. A suchlike applicator unit is described, for example, in DE 10 2010 031 558.

However, since the curtain is highly susceptible to external disturbances such as airflows, among other things because of its small thickness, the coating unit is frequently provided with an enclosure. The air inside this enclosure is naturally very moist, since moisture is introduced into the interior of the enclosure both via the fibrous web and via the coating medium. This moisture is able to condense at cool points and is able to drip in the form of water droplets, for example onto the material web, and to damage it.

In order to prevent this, enclosures which are operated with air conditioning are known from the prior art. In this case, the hot, moist air is extracted from the enclosure by suction, while cooled or dried air is blown into the enclosure. The temperature inside the enclosure can be maintained at a largely constant level with air conditioning of this kind.

Suchlike air conditioning exhibits various disadvantages, however. Moist and warm air, which is entrained by the moving material web, is thus able to continue to penetrate into the enclosure through openings in the enclosure, for example through the inlet slot for the material web. This air must be extracted once more, which involves additional costs. In addition, the air conditioning system is rather complex and is associated with not insignificant costs in respect of its procurement and operation. The coating device can be operated either not at all, or only to a limited extent, in order to enable necessary maintenance operations to be carried out. One object of the invention is to make available a coating device and a method for operating a coating device, which overcome the problems of the prior art.

A further object of the invention is to propose a coating device, the operation of which requires less energy than in the prior art.

In addition, an object of the invention is to facilitate the stable operation of the coating device.

These objects are accomplished completely by a method for coating a material web according to the characterizing part of claim 1.

The object is accomplished completely by a method for coating a material web, in particular a fibrous web, by means of a coating device, wherein the coating device comprises an application unit for the application of a coating medium to the material web as well as an enclosure, and wherein the application unit is arranged in the interior of the enclosure, and the enclosure comprises a first opening for the entry of the material web as well as a second opening for the exit of the material web.

According to the invention, it is proposed that a positive pressure greater than the ambient pressure outside the enclosure is produced inside the enclosure during the coating process, so that air flows from the interior of the enclosure through the first opening and/or the second opening from the enclosure to the outside.

According to the present invention, the damp and warm air is thus not extracted actively from the enclosure by suction, but escapes passively through the openings in the enclosure. An enclosure of a coating device cannot be hermetically sealed. Openings, through which the air is able to escape, are always present between the inlet and in particular the outlet for the material web. Other openings can also be present, however, through which the air is able to escape, for example maintenance openings, access doors or the like.

The escape of the air through the inlet openings for the material web has a further, very advantageous effect. This airflow that is directed outward along or in the vicinity of the material web counteracts the entrainment air, which would otherwise be entrained into the enclosure together with the incoming material web. This entrainment air is usually moist and warm relative to the normal climate (23° C., 50% relative humidity). This heat and the moisture thus usually make their way into the enclosure together with the entrainment air. However, in one embodiment of the method described here, this entrainment air is retained in full or in part outside the enclosure by the outflowing air.

Advantageous embodiments of the method are described in the dependent claims.

In one particularly advantageous embodiment of the method, the coating device in question can be a curtain application device. In suchlike curtain application devices, the coating medium falls in the form of a thin curtain onto the moving material web under the effect of gravity.

In this case, the application in question can be a single-layer or multi-layer application.

It can also be proposed advantageously that two, three or more coating devices are provided inside the enclosure. In this case, the coating devices in question can be identical or different coating devices.

In a preferred embodiment, it can be proposed that the positive pressure is created by blowing an airflow into the enclosure. As an alternative, or in addition, air can also be introduced into the enclosure from outside by suction. In this case, the airflow can be further conditioned before being blown into the enclosure by causing it to be cooled, heated or dried, as required, for the application.

This conditioning preferably takes place outside the enclosure.

In a further advantageous embodiment of the invention, it can be proposed that the air flow, which is blown or sucked into the enclosure, is more than 1000 m³/h, in particular more than 4000 m³/h, and in particular between 8000 m³/h and 13000 m³/h. The air volume can also be varied, as necessary, during operation of the coating device. The air volume can thus be increased, for example, if the operating speed of the coating device is increased.

In further advantageous embodiments, it can be proposed that the airflow is blown or sucked into the enclosure at a temperature of less than 23° C., preferably less than 20° C., and most preferably less than 15° C.

This relatively cool air is then heated as a rule inside the enclosure, for example by the material web, and usually exits the enclosure at a temperature higher than that when it enters the enclosure.

In common applications, the incoming material web will exhibit a temperature of more than 30°, and frequently even more than 40° C., at the surface.

It can also be proposed advantageously that the volumetric flow and/or the temperature and/or the moisture content of the air blown in is measured. This measurement can take place selectively in each case, or also continuously during operation of the coating device.

In preferred embodiments, it can be proposed that the air pressure is measured at at least one point in the interior of the enclosure.

As an alternative or in addition, measurement of the ambient pressure can also take place outside the enclosure.

The difference between the pressure outside and inside the enclosure can be utilized, for example, to regulate or control the supply of air into the interior of the enclosure.

It can be proposed, in particular, that the positive pressure in the interior of the enclosure, with respect to the ambient pressure outside the enclosure, is at least 8 Pa. Higher positive pressures, for example 10 Pa, 12 Pa, 15 Pa, 20 Pa or more, can also be advantageous.

It can also be proposed that the positive pressure in the interior of the enclosure is maintained at a constant level, or that it is variable. It can be proposed, in particularly advantageous embodiments, that the overpressure is varied depending on process parameters such as the speed of the material web, for example.

In particularly preferred embodiments, it can be proposed that the air supplied via the air flow escapes by more than 50%, preferably by more than 80% and most preferably completely passively from the enclosure through one or more openings.

No extraction system for the enclosure is required in embodiments in which the air escapes completely passively via the openings. This reduces the cost of maintenance for the coating device as well as the operating costs. An extraction system may be provided in embodiments in which a proportion of the air does not escape passively through the openings. This can be dimensioned on an appropriately small scale, however, which significantly reduces the cost compared with complete extraction.

An advantage also associated with the presence of partial extraction is the possibility of decoupling the quantity of air blown in or introduced by suction from the quantity of air which escapes passively via the openings. The coating device can thus be operated in such a way, for example, that a fixed quantity of air is supplied to the enclosure. The positive pressure arising inside the enclosure can then be adjusted, for example, by the partial extraction of the air from the enclosure. This is particularly advantageous if provision is made for pressure measurements to be taken inside and/or outside the enclosure.

In a further advantageous embodiment of the method, provision can be made for the material web to have passed through a drying process and/or a further coating process before entry into the coating device. The temperature of the material web and the moisture entrained by it are especially high in such a case, and the advantages of the method are particularly significant.

The invention is explained in more detail below on the basis of a figure.

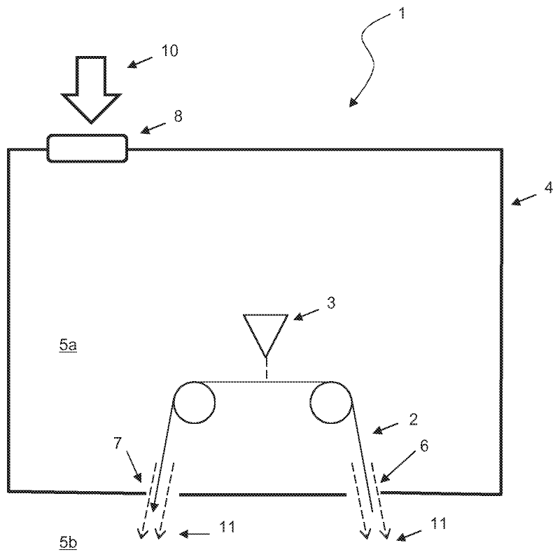

FIG. 1 depicts a coating device for the implementation of one aspect of the inventive method.

Depicted in FIG. 1 is a coating device 1, in which an application unit 3 configured as a curtain application unit 3 is arranged in the interior 5a of an enclosure 4. The material web 2 in question, which may be a paper web or a board web 2, for example, is led through a first opening 6, usually a slot, into the interior 5a of the enclosure 4, and is coated there with a coating medium by means of the coating unit 3. Commonly-used coating media are pigment-containing coating colors, which may contain CaCO₃ or TiO₂, for example. Materials such as polyvinyl alcohol (PVA) have also found an application more recently as a result of their use as a barrier coating. However, other coating materials may also find an application. After coating, the material web 2 exits from the enclosure 4 through a second opening 7. Although only coating with a curtain application unit 3 is illustrated here by way of example, the invention also includes embodiments in which other application units 3 find an application. Similarly, a number of application units 3 may also be provided in the enclosure 4.

In the embodiment depicted in FIG. 1, an airflow 10 is led into the interior 5a of the enclosure 4 via a fan 8 or some other suitable inlet 8 for the purpose of air-conditioning the enclosure 4. This results in a pressure in the interior 5a of the enclosure 4 which is greater than the pressure outside 5b the enclosure 4. This airflow 10 may exhibit a temperature of less than 23° C., for example. This serves to cool the interior 5a, since heat is introduced continuously into the interior 5a of the enclosure by the material web 2, whereby the latter would heat up without air conditioning. In addition, it could result in the condensation of the moisture present in this air, for example on cool component parts of the application unit 3. If this condensed moisture drips onto the material web 2, for example, the coating or even the material web 2 may be damaged.

Since the pressure in the interior 5a is greater than the pressure outside 5b, the air will escape from the enclosure 4 via existing openings 6, 7. In particular, exit flows 11 will escape from the first opening 6 and the second opening 7. The exit flow 11 from the first opening 6 in particular is advantageous. In fact, this counteracts the entrainment air entrained by the material web 2. This entrained air is particularly warm and moist. If this entrained air is retained fully or partially outside the enclosure 4, the cost of air conditioning the enclosure falls as well as the energy required for that purpose.

In the embodiment illustrated in FIG. 1, the whole of the air supplied via the airflow 10 escapes passively from the enclosure 4 through openings 6, 7. In other embodiments, however, provision can be made for a proportion of this air, for example less than 50% and in particular less than 20%, to be removed actively from the enclosure 4 by suction.

1-10. (canceled)

11. A method of coating a material web (2), the method comprising:
providing a coating device (1) with an application unit (3) for applying a coating medium to the material web (2) and an enclosure (4), wherein the application unit (3) is disposed in an interior (5a) of the enclosure (4), and the enclosure (4) is formed with a first opening (6) enabling the material web (2) to enter and a second opening (7) enabling the material web (2) to exit from the interior (5a);
during a coating process, producing a positive pressure inside the enclosure (4) that is greater than an ambient pressure outside (5b) the enclosure (4), to cause air to flow from the interior (5a) of the enclosure (4) through the first opening (6) and/or the second opening (7) to the outside (5b) of the enclosure.

12. The method according to claim 11, wherein the application unit (3) is a curtain application unit (3).

13. The method according to claim 11, wherein the step of producing the positive pressure comprises blowing an airflow (10) into the enclosure or aspirating an airflow (10) out of the enclosure (4).

14. The method according to claim 13, which comprises adjusting the air flow (10) to more than 1000 m³/h.

15. The method according to claim 13, which comprises adjusting the air flow (10) to more than 4000 m³/h.

16. The method according to claim 13, which comprises adjusting the air flow (10) to between 8000 m³/h and 13000 m³/h.

17. The method according to claim 11, which comprises blowing the airflow (10) into the enclosure (4) at a temperature of less than 23° C.

18. The method according to claim 17, which comprises blowing the airflow (10) into the enclosure (4) at a temperature of less than 20° C.

19. The method according to claim 18, which comprises blowing the airflow (10) into the enclosure (4) at a temperature of less than 15° C.

20. The method according to claim 11, which comprises measuring at least one parameter selected from the group consisting of a volumetric flow of the air being blown into the enclosure, a temperature of the air being blown into the enclosure, and a moisture content of the air being blown into the enclosure.

21. The method according to claim 11, which comprises measuring an air pressure inside the enclosure (4) at at least one point in the interior (5a) of the enclosure (4).

22. The method according to claim 11, which comprises adjusting the positive pressure in the interior (5a) of the enclosure (4), relative to the ambient pressure outside (5b) the enclosure (4), to at least 8 Pa.

23. The method according to claim 22, which comprises adjusting the positive pressure in the interior (5a) of the enclosure (4), relative to the ambient pressure outside (5b) the enclosure (4), to at least 12 Pa.

24. The method according to claim 11, which comprises causing the air that is supplied via the air flow (10) to escape from the enclosure through one or more of the openings (6, 7) by more than 50%.

25. The method according to claim 11, which comprises causing the air that is supplied via the air flow (10) to escape from the enclosure through one or more of the openings (6, 7) by more than 80%.

26. The method according to claim 11, which comprises enabling the air that is supplied via the air flow (10) to escape completely passively from the enclosure through one or more of the openings (6, 7).
